(19) United States
(12) Patent Application Publication
(10) Pub. No.: US 2025/0252324 A1
(43) Pub. Date: Aug. 7, 2025

(54) SYSTEM AND METHOD FOR GENERATION OF KNOWEDGE GRAPHS USING PRE-EXISTING ONTOLOGIES

(71) Applicant: EATON INTELLIGENT POWER LIMITED, Dublin 4 (IE)

(72) Inventors: Tony MARRERO, Dublin 7 (IE); Catriona CLARKE, Newbridge, Kildare (IE); Adi BOTEA, Dublin (IE)

(21) Appl. No.: 18/856,688

(22) PCT Filed: Apr. 14, 2022
(86) PCT No.: PCT/EP2022/025149

§ 371 Date: Oct. 14, 2024

(51) Int. Cl. G06N 5/022; G06F 16/2457

(52) U.S. Cl. CPC G06N 5/022; G06F 16/24578

(57) ABSTRACT

Some embodiments relate to a computer-implemented method and system, wherein the method includes generating a knowledge graph from a plurality of isolated data sources. The method includes reading data from the plurality of isolated data sources; analysing the data using semantic analysis and natural language processing vectorisation and obtaining a first knowledge graph ontology. An output from the analysis can be updated data processed based on data quality. A category of low quality data can include data having a data quality score below a predefined threshold. The method can include accessing the first knowledge graph ontology; obtaining information related to one or more previously completed knowledge graphs and ontologies; applying transfer learning to generate new candidate ontologies; utilising ranking scores to select a final ontology from the candidate ontologies; and generating a knowledge graph using the selected final ontology.

### CROSS-REFERENCE TO RELATED APPLICATIONS

This application is a national phase filing under 35 C.F.R. § 371 of and claims priority to PCT Patent Application No. PCT/EP2022/025149, filed on Apr. 14, 2022, the contents of which are hereby incorporated in its entirety by reference.

### FIELD OF THE DISCLOSURE

The presently disclosed subject matter relates to a computer-implemented method of generating a knowledge graph from a plurality of isolated data sources using pre-existing ontologies.

### BACKGROUND OF THE DISCLOSURE

Large organizations often end up with siloed datasets, lacking a holistic representation of knowledge. This severely limits the ability to consider all relevant knowledge in applications such as servicing and controlling circuit breakers and other physical devices. We address the technical problem of connecting siloed data.

Knowledge graphs (KGs) are powerful tools to aggregate data in one representation and reason holistically on the relevant knowledge. However, constructing a KG can be challenging, especially under conditions having unstructured data, different data formats, and sources with seemingly disjoint schemas.

Applications such as monitoring physical devices (e.g. circuit breakers), in order to make decisions about their maintenance, servicing and optimization, are important in many applications, such as utilities and production facilities. These applications require the ability to connect relevant knowledge that come from different sources, which is challenging when the volume of data is large, or the data is incomplete, noisy, or split into siloes. For example, accurately deciding whether a circuit breaker needs servicing can depend on past experience with other circuit breakers, located in a different remote location, but operated under similar conditions (e.g., humidity, usage patterns) to the device at hand.

Therefore, there is a need to provide a method and system which deals with complex and large amounts of siloed data sources, from where a holistic KG needs to be created to provide analytics, extract meaningful insights from the data, or perform Machine Learning or Artificial Intelligence tasks.

### SUMMARY OF THE DISCLOSURE

According to a first aspect of the presently disclosed subject matter, there is provided a computer-implemented method of generating a knowledge graph from a plurality of isolated data sources, the computer-implemented method comprising: reading data from the plurality of isolated data sources; analysing the data using semantic analysis and natural language processing vectorisation and obtaining a first knowledge graph ontology, wherein an output from the analysis is updated data; processing the updated data based on data quality, wherein data quality is determined by generating a data quality score, further wherein a category of low quality data comprises the data having a data quality score below a predefined threshold, the method further arranged to apply a correction step to data in the category of low quality data and outputting corrected data; accessing the first knowledge graph ontology; obtaining, from an existing knowledge graph database, information related to one or more previously completed knowledge graphs and ontologies; applying transfer learning to generate new candidate ontologies; utilising ranking scores to select a final ontology from the candidate ontologies, wherein the selection is based on the highest ranking score; generating a knowledge graph using the selected final ontology.

Preferably, the method further comprises: identifying and correcting data issues; detecting connections in the isolated data from the isolated data sources by analysing the data using NLP and semantic analysis; and determining a similarity score between the isolated data from the isolated data sources.

Preferably, the generated knowledge graph is stored in the existing knowledge graph database.

Preferably, the generated knowledge graph is used to perform one of monitoring, servicing, or controlling a device associated with the generated knowledge graph.

Preferably, prior to accessing the first knowledge graph ontology, the computer-implemented method comprises: generating a data quality report.

Preferably, generating the data quality report comprises: generating a quality score which summarises the corrected data.

Preferably, the analysing the data using semantic analysis and natural language processing vectorisation comprises: generating a numerical descriptor which represents the analysed data.

Preferably, generating new candidate ontologies comprises: defining a search space that at least partially matches to the data, wherein the search space is explored using a searching algorithm; applying an evaluation function to evaluate an efficacy of whether the search space matches to the data.

According to a second aspect of the presently disclosed subject matter, there is provided a system for generating a knowledge graph from a plurality of isolated data sources; the system comprising: a plurality of sensors; a centralised repository; wherein the centralised repository is configured to perform the method in accordance with the first aspect.

### DETAILED DESCRIPTION OF THE DRAWINGS

Embodiments of the presently disclosed subject matter will now be described by way of example only and with reference to the accompanying drawings, in which:

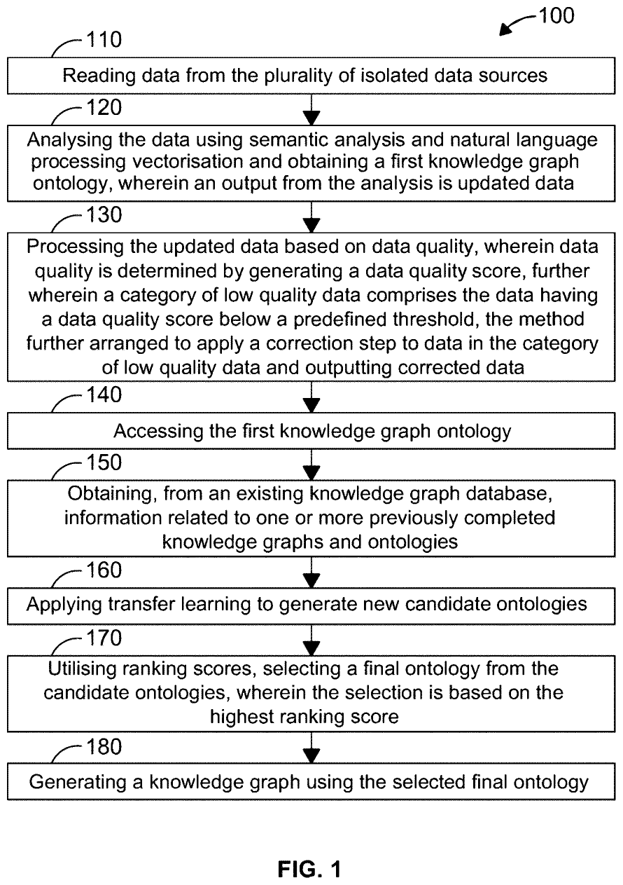

FIG. 1 depicts a method in accordance with the first aspect of the presently disclosed subject matter.

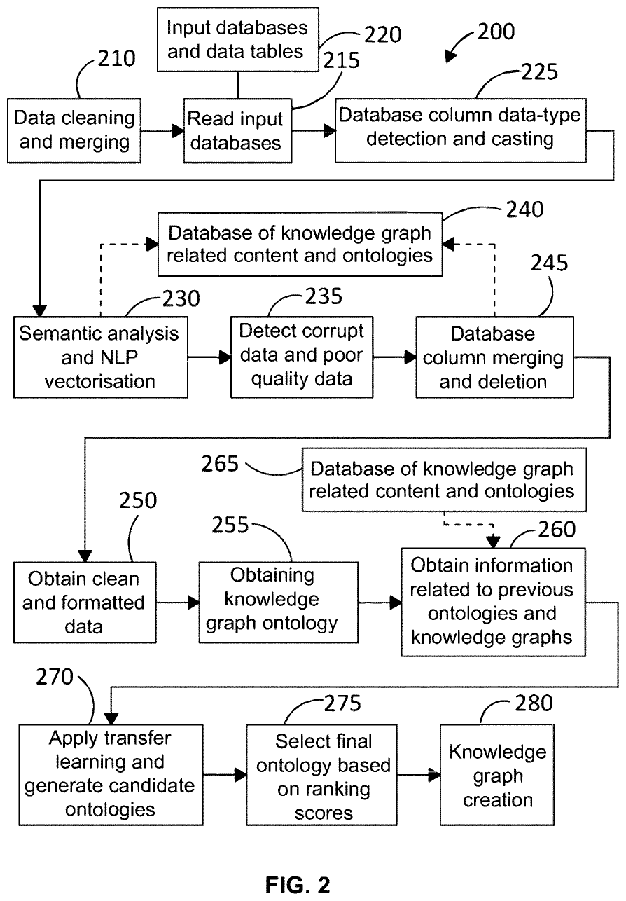

FIG. 2 depicts a flow diagram which shows further aspects of the method in accordance with the first aspect of the presently disclosed subject matter.

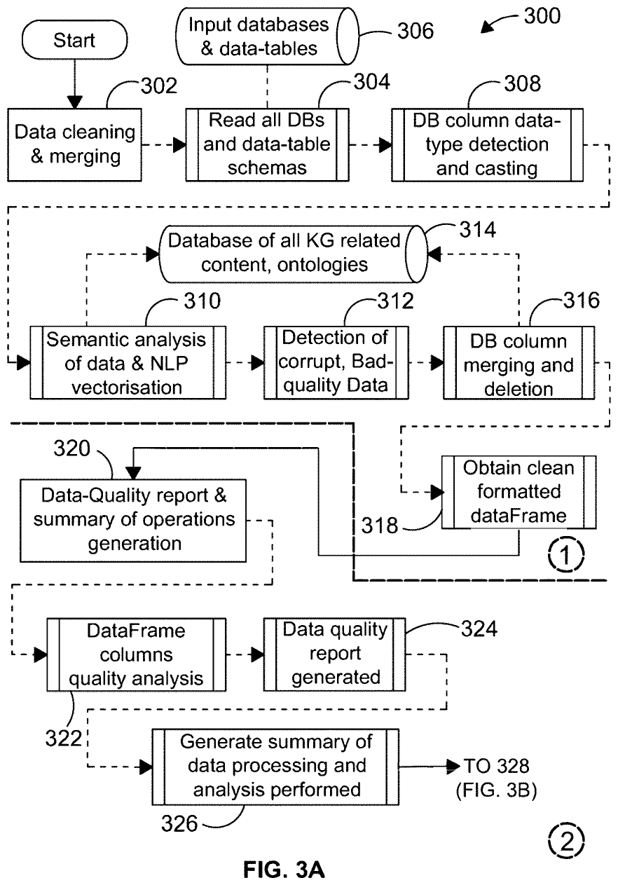

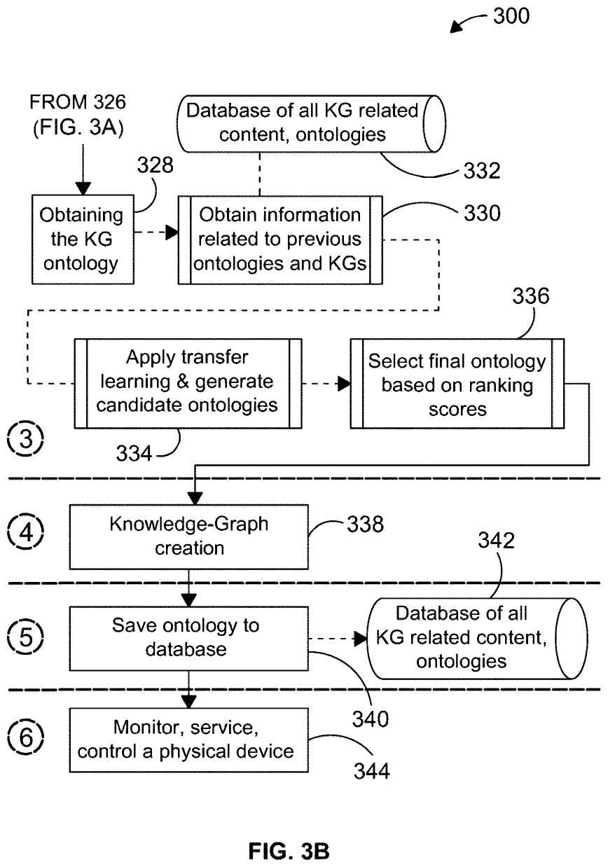

FIGS. 3A and 3B depicts a flow diagram which shows further aspects of the method in accordance with the first aspect of the presently disclosed subject matter.

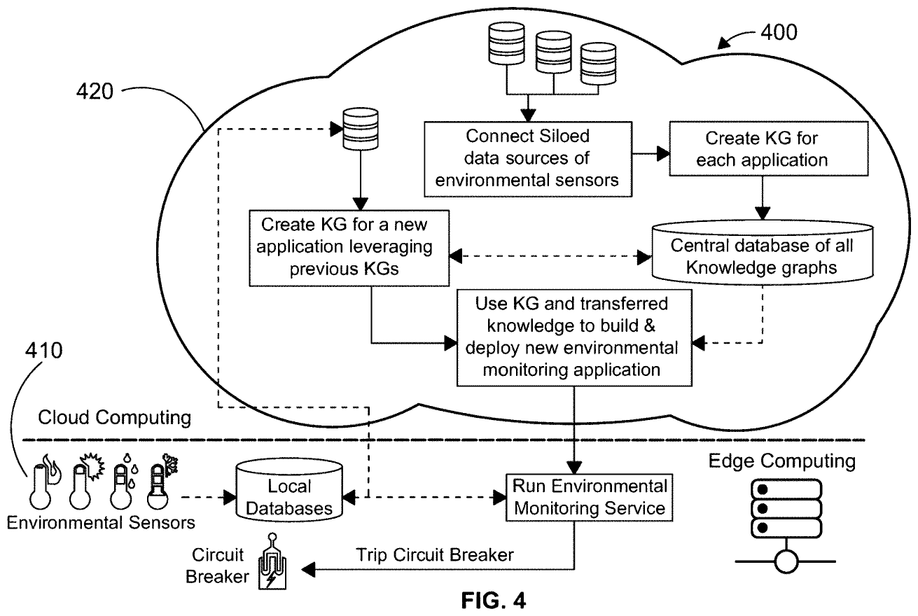

FIG. 4 depicts an example of a system in accordance with the second aspect of the presently disclosed subject matter.

With reference to FIG. 1, this depicts a method comprising steps 110-180. Step 110 comprises reading data from the plurality of isolated data sources. Step 120 comprises analysing the data using semantic analysis and natural language processing vectorisation and obtaining a first knowledge graph ontology, wherein an output from the analysis is updated data. Step 130 comprises processing the updated data based on data quality, wherein data quality is determined by generating a data quality score, further wherein a category of low quality data comprises the data having a data quality score below a predefined threshold, the method further arranged to apply a correction step to data in the category of low quality data and outputting corrected data. Step 140 comprises accessing the first knowledge graph ontology. Step 150 comprises obtaining, from an existing knowledge graph database, information related to one or more previously completed knowledge graphs and ontologies. Step 160 comprises applying transfer learning to generate new candidate ontologies. Step 170 comprises utilising ranking scores, selecting a final ontology from the candidate ontologies, wherein the selection is based on the highest ranking score. Step 180 comprises generating a knowledge graph using the selected final ontology.

With reference to FIG. 2, this depicts a flow diagram further depicting further aspects in of the method of FIG. 1, comprising steps 210 to 280. Step 210 comprises data cleaning and merging; step 215 comprises reading input databases from the input databases and data tables as depicted in step 220. Step 225 comprises a detection and casting of database column data types. Step 230 comprises a semantic analysis and a natural language processing (NLP) of the database columns of step 225. The output of step 230 is transmitted to a database of knowledge graph related content and ontologies, as depicted in step 240; and the method continues to step 235, which comprises detecting corrupt data and/or poor quality data. Step 245 comprises database column merging and the deletion of any corrupt and/or poor quality data, and the output of this step is transmitted to the database of knowledge graph related content and ontologies, as depicted in step 240. Step 250 comprises obtaining clean data (i.e. where any corrupt and/or poor quality data is deleted) and formatted data.

Step 255 comprises obtaining knowledge graph ontology, step 260 comprises obtaining information related to previous ontologies and knowledge graphs, where this information is retrieved from the database of knowledge graph related content and ontologies, as depicted in step 265. Step 270 comprises applying transfer learning and generate candidate ontologies. Step comprises selecting a final ontology based on ranking scores, and step 280 creating a knowledge graph.

With reference to FIGS. 3A-3B, these depict a flow diagram further depicting further aspects in of the method of FIG. 1, comprising steps 302 to 344. Some of the steps of FIGS. 3A-3B have been described in relation to FIG. 2. In particular steps 210 to 280 of FIG. 2 are the same as steps 302 to 318 of FIG. 3A and steps 328 to 338 of FIG. 3B.

FIG. 3A further depicts steps 320 to 326 and FIG. 3B further depicts steps 340 to 344. Steps 320 to 326 generally relate to the production of a data quality report which summarises the data quality and the results of the semantic analysis and NLP vectorisation analysis. In particular, step 320 comprises generating a data quality report and a summary of the operations performed, based on the data from step 318 of FIG. 3A (i.e. step 250 of FIG. 2). Step 322 comprises performing a data quality analysis from the data frame columns. Step 324 comprises generating a data quality report, and step 326 comprises generating a summary of the performed data processing and analysis.

Step 340 comprises storing the ontology generated in step 336 of FIG. 3B (i.e. step 275 of FIG. 2). The ontology is stored in the database of all knowledge graph related content and ontologies, as depicted in step 342. Step 344 comprises monitoring, servicing and/or controlling a physical device.

With reference to FIG. 4, this depicts a system 400 in accordance with an aspect of the presently disclosed subject matter. The system 400 comprises a plurality of sensors 410 (e.g. environmental sensors). The plurality of sensors 410 are configured to monitor, service and/or control a physical device (e.g. a circuit breaker). The system 400 comprises a centralised repository 420. The plurality of sensors 410 transmit their data to a centralised repository 420 (e.g. the cloud). The centralised repository 420 is configured to perform the method according to another aspect of the presently disclosed subject matter.

It will be appreciated that the above described embodiments of the first and second aspects of the presently disclosed subject matter are given by way of example only, and that various modifications may be made to the embodiments without departing from the scope of the presently disclosed subject matter as defined in the appended claims.

1. A computer-implemented method of generating a knowledge graph from a plurality of isolated data sources, the computer-implemented method comprising:
reading data from the plurality of isolated data sources;
analysing the data using semantic analysis and natural language processing vectorisation and obtaining a first knowledge graph ontology, wherein an output from the analysis is updated data;
processing the updated data based on data quality, wherein data quality is determined by generating a data quality score, further wherein a category of low quality data comprises the data having a data quality score below a predefined threshold, the method further arranged to apply a correction step to data in the category of low quality data and outputting corrected data;
accessing the first knowledge graph ontology;
obtaining, from an existing knowledge graph database, information related to one or more previously completed knowledge graphs and ontologies;
applying transfer learning to generate new candidate ontologies;
utilising ranking scores to select a final ontology from the candidate ontologies, wherein the selection is based on the highest ranking score;
generating a knowledge graph using the selected final ontology.

2. The computer-implemented method of claim 1, wherein the method further comprises:
identifying and correcting data issues;
detecting connections in the isolated data from the isolated data sources by analysing the data using NLP and semantic analysis; and
determining a similarity score between the isolated data from the isolated data sources.

3. The computer-implemented method of claim 1, wherein the generated knowledge graph is stored in the existing knowledge graph database.

4. The computer-implemented method of claim 1, wherein the generated knowledge graph is used to perform one of monitoring, servicing, or controlling a device associated with the generated knowledge graph.

5. The computer-implemented method of claim 1, wherein prior to accessing the first knowledge graph ontology, the computer-implemented method comprises:
generating a data quality report.

6. The computer-implemented method of claim 5, wherein generating the data quality report comprises: generating a quality score which summarises the corrected data.

7. The computer-implemented method of claim 1, wherein the analysing the data using semantic analysis and natural language processing vectorisation comprises:
generating a numerical descriptor which represents the analysed data.

8. The computer-implemented method of claim 1, wherein generating new candidate ontologies comprises:
defining a search space that at least partially matches to the data, wherein the search space is explored using a searching algorithm;
applying an evaluation function to evaluate an efficacy of whether the search space matches to the data.

9. A system for generating a knowledge graph from a plurality of isolated data sources; the system comprising:
a plurality of sensors;
a centralised repository;
wherein the centralised repository is configured to perform a method comprising:
reading data from the plurality of isolated data sources;
analysing the data using semantic analysis and natural language processing vectorisation and obtaining a first knowledge graph ontology, wherein an output from the analysis is updated data;
processing the updated data based on data quality, wherein data quality is determined by generating a data quality score, further wherein a category of low quality data comprises the data having a quality score below a predefined threshold, the method further arranged to apply a correction step to data in the category of low quality data and outputting corrected data;
assessing the first knowledge graph ontology;
obtaining, from an existing knowledge graph database, information related to one or more previously completed knowledge graphs and ontologies;
applying transfer learning to generate new candidate ontologies;
utilizing ranking scores to select a final ontology from the candidate ontologies, wherein the selection is based on the highest ranking score;
generating a knowledge graph using the selected final ontology.

10. The system of claim 9, wherein the centralised repository is further configured to perform:
identifying and correcting data issues;
detecting connections in the isolated data from the isolated data sources by analysing the data using NLP and semantic analysis; and
determining a similarity score between the isolated data from the isolated data sources.

11. The system of claim 9, wherein the generated knowledge graph is stored in the existing knowledge graph database.

12. The system of claim 9, wherein the centralised repository is further configured to perform:
using the generated knowledge graph perform one of monitoring, servicing, or controlling a device associated with the generated knowledge graph.

13. The system of claim 9, wherein the centralised repository is further configured, prior to accessing the first knowledge graph ontology, to generate a data quality report.

14. The system of claim 13, wherein the centralised repository is further configured, when generating the data quality report, to generate a quality score which summarises the corrected data.

15. The system of claim 9, wherein the centralised repository is further configured, when analysing the data using semantic analysis and natural language processing vectorisation, to generate a numerical descriptor which represents the analysed data.

16. The system of claim 9, wherein the centralised repository is further configured, when generating new candidate ontologies, to:
define a search space that at least partially matches to the data, wherein the search space is explored using a searching algorithm;
apply an evaluation function to evaluate an efficacy of whether the search space matches to the data.
